(19) United States
(12) Patent Application Publication
(10) Pub. No.: US 2016/0005231 A1
(43) Pub. Date: Jan. 7, 2016

(54) IMAGE DISPLAY DEVICE

(71) Applicant: Seiko Epson Corporation, Tokyo (JP)

(72) Inventor: Hirokazu YAMAGA, Chino (JP)

(21) Appl. No.: 14/755,124

(22) Filed: Jun. 30, 2015

(30) Foreign Application Priority Data
Jul. 1, 2014 (JP) 2014-135915

(51) Int. Cl. G06T 19/00; G02B 27/01

(52) U.S. Cl. CPC G06T 19/006; G02B 27/0176; G02B 2027/0178; G02B 2027/0154

(57) ABSTRACT

An image display device used while mounted on a head of an observer includes: a left-eye display unit having an optical section adapted to form a virtual image for a left eye of the observer; a right-eye display unit having an optical section adapted to form a virtual image for a right eye of the observer; and an interpupillary adjustment mechanism adapted to adjust a distance between the left-eye display unit and the right-eye display unit, wherein the interpupillary adjustment mechanism includes a first adjustment mechanism capable of simultaneously adjusting a position of the left-eye display unit and a position of the right-eye display unit, and a second adjustment mechanism capable of independently adjusting only either one of the position of the left-eye display unit and the position of the right-eye display unit.

### BACKGROUND

1. Technical Field

The present invention relates to an image display device.

2. Related Art

There has been put into practice a head mount display (HMD), which is used while being mounted on the head of the observer, and displays an image visually recognized by the observer as a virtual image (see, e.g., JP-A-2007-81984).

Such a head mount display has an adjustment mechanism for adjusting the distance (interpupillary distance) between a display unit for the left eye and a display unit for the right eye. This adjustment mechanism is arranged so as to interlock the display unit for the left eye and the display unit for the right eye with each other to be displaced symmetrically.

However, since the human body is not bilaterally symmetric, if the interpupillary adjustment is performed using an adjustment mechanism of the head mount display of the related art, the interpupillary distance fails to appropriately be adjusted in some cases depending on the observer.

### SUMMARY

An advantage of the invention is to provide an image display device capable of appropriately and promptly achieving the interpupillary adjustment for each observer.

The invention can be implemented as the following aspects of the invention.

An image display device according to an aspect of the invention is an image display device used while mounted on a head of an observer including a left-eye display unit having an optical section adapted to form a virtual image for a left eye of the observer, a right-eye display unit having an optical section adapted to form a virtual image for a right eye of the observer, and an interpupillary adjustment mechanism adapted to adjust a distance between the left-eye display unit and the right-eye display unit, and the interpupillary adjustment mechanism includes a first adjustment mechanism capable of simultaneously adjusting a position of the left-eye display unit and a position of the right-eye display unit, and a second adjustment mechanism capable of independently adjusting only either one of the position of the left-eye display unit and the position of the right-eye display unit.

According to this configuration, the interpupillary adjustment can appropriately be performed for every observer, and it is possible to form the virtual image at the correct position for each of the right and left eyes.

Further, the interpupillary adjustment can promptly be achieved compared to the case in which the interpupillary adjustment mechanism is formed of the adjustment mechanism capable of independently adjust only the position of the left-eye display unit and the adjustment mechanism capable of independently adjust only the position of the right-eye display unit. Specifically, in the interpupillary adjustment, firstly, either one of the position of the left-eye display unit and the position of the right-eye display unit is adjusted while displacing the left-eye display unit and the right-eye display unit using the first adjustment mechanism. At this stage, the coarse adjustment is complete with respect to the other thereof. Subsequently, by adjusting (fine adjustment) the other thereof using the second adjustment mechanism, the interpupillary adjustment can promptly be performed.

In the image display device according to the aspect of the invention, it is preferable that the interpupillary adjustment mechanism includes a lead screw provided with a first male screw section provided with a screw thread formed in a first screw direction, and a second male screw section provided with a screw thread formed in a second screw direction different from the first screw direction, a left-eye support section adapted to support the left-eye display unit, and a right-eye support section adapted to support the right-eye display unit, either one of the left-eye support section and the right-eye support section is provided with a female screw to be screwed with the first male screw, and the other of the left-eye support section and the right-eye support section is provided with a screw coupling section, which has an inner peripheral surface provided with a female screw to be screwed with the second male screw, and is rotatable with respect to the other of the left-eye support section and the right-eye support section.

According to this configuration, by rotating the lead screw, it is possible to simultaneously displace the left-eye display unit and the right-eye display unit in the respective directions opposite to each other, and further, by rotating the screw coupling section, it is possible to displace only either one of the left-eye display unit and the right-eye display unit. Thus, the interpupillary adjustment can appropriately and promptly be performed for every observer.

In the image display device according to the aspect of the invention, it is preferable to further include a rotation restriction section adapted to restrict a rotation of the screw coupling section when rotating the lead screw, and not to restrict a rotation of the screw coupling section when rotating the screw coupling section.

According to this configuration, by rotating the lead screw in the state in which the rotation of the screw coupling section is restricted by the rotation restriction section, it is possible to more surely displace the left-eye display unit and the right-eye display unit simultaneously in the respective directions opposite to each other.

In the image display device according to the aspect of the invention, it is preferable that the rotation restriction section has a projection section provided to the other of the left-eye support section and the right-eye support section, and having pressure contact with the screw coupling section.

According to this configuration, it is possible to more surely restrict the rotation of the screw coupling section when rotating the lead screw while allowing the observer to rotate only the screw coupling section when directly applying force to the screw coupling section.

In the image display device according to the aspect of the invention, it is preferable that the screw coupling section has a recessed section to which the projection section is inserted.

According to this configuration, it is possible to more surely restrict the rotation of the screw coupling section when rotating the lead screw while allowing the observer to rotate only the screw coupling section when directly applying force to the screw coupling section.

In the image display device according to the aspect of the invention, it is preferable to further include a clutch adapted to switch between a rotation-restricted state in which a relative rotation between the screw coupling section and the other of the left-eye support section and the right-eye support section is restricted, and a rotation-allowed state in which the relative rotation between the screw coupling section and the other of the left-eye support section and the right-eye support section is allowed.

According to this configuration, by rotating the lead screw after setting the rotation-restricted state, it is possible to simultaneously displace the left-eye display unit and the right-eye display unit in the respective directions opposite to each other, and further, by rotating the lead screw after setting the rotation-allowed state, it is possible to displace only either one of the left-eye display unit and the right-eye display unit. Thus, the interpupillary adjustment can appropriately and promptly be performed for every observer.

In the image display device according to the aspect of the invention, it is preferable that the clutch is fitted into a space formed between an outer peripheral surface of the screw coupling section and the other of the left-eye support section and the right-eye support section in the rotation-restricted state, and the fit of the clutch into the space is released in the rotation-allowed state.

According to this configuration, it is possible to more surely switch between the rotation-restricted state and the rotation-allowed state.

In the image display device according to the aspect of the invention, it is preferable that the outer peripheral surface of the screw coupling section is tilted with respect to an axial direction of the lead screw.

According to this configuration, it is possible to easily and surely switch between the rotation-restricted state and the rotation-allowed state.

In the image display device according to the aspect of the invention, it is preferable that the clutch has a cylindrical section having a cylindrical shape, and an inner peripheral surface of the cylindrical section is tilted with respect to an axial direction of the lead screw.

According to this configuration, it is possible to easily and surely switch between the rotation-restricted state and the rotation-allowed state.

### BRIEF DESCRIPTION OF THE DRAWINGS

The invention will be described with reference to the accompanying drawings, wherein like numbers reference like elements.

FIG. 1 is a perspective view showing a schematic configuration of an image display device (head mount display) according to a first embodiment of the invention.

FIG. 2 is a perspective view showing a schematic configuration of a principal part of the image display device shown in FIG. 1.

FIG. 3 is a perspective view showing a schematic configuration of the vicinity of a right-eye image forming unit of the image display device shown in FIG. 1.

FIG. 4 is a perspective view showing a schematic configuration of the vicinity of an interpupillary adjustment mechanism of the image display device shown in FIG. 1.

FIG. 5 is a cross-sectional view showing a schematic configuration of the vicinity of a screw coupling section (a roller) of the image display device shown in FIG. 1.

FIG. 6 is a block diagram of the image display device shown in FIG. 1.

FIG. 7 is a perspective view showing a schematic configuration of an image display device (head mount display) according to a second embodiment of the invention.

FIG. 8 is a perspective view showing a schematic configuration of the vicinity of an interpupillary adjustment mechanism of the image display device shown in FIG. 7.

FIG. 9 is a cross-sectional view showing a schematic configuration of the vicinity of a clutch mechanism of the image display device shown in FIG. 7.

FIGS. 10A and 10B are cross-sectional views respectively showing a rotation-restricted state and a rotation-allowed state of the image display device shown in FIG. 7.

### DESCRIPTION OF EXEMPLARY EMBODIMENTS

The image display device according to the invention will hereinafter be explained in detail based on the embodiments shown in the accompanying drawings.

### First Embodiment

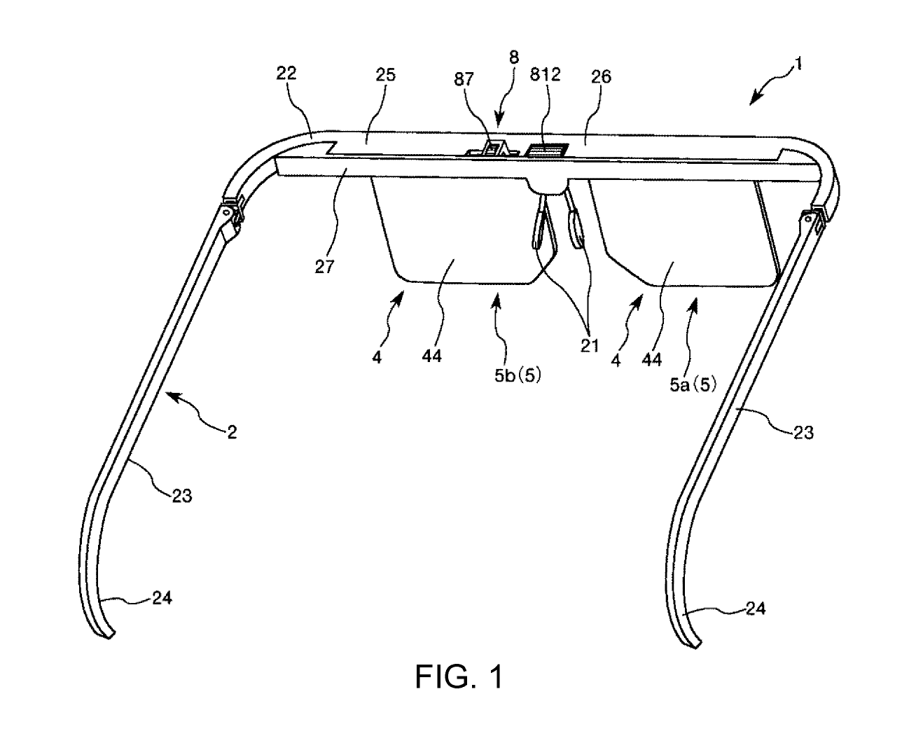

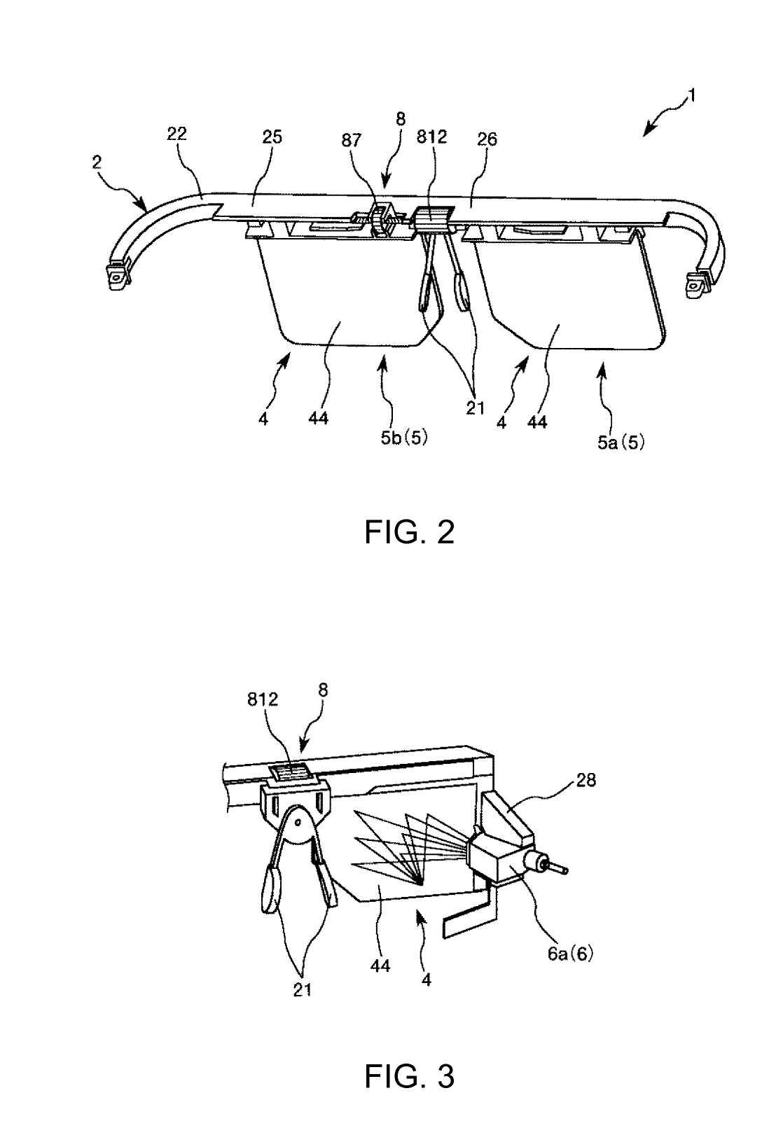

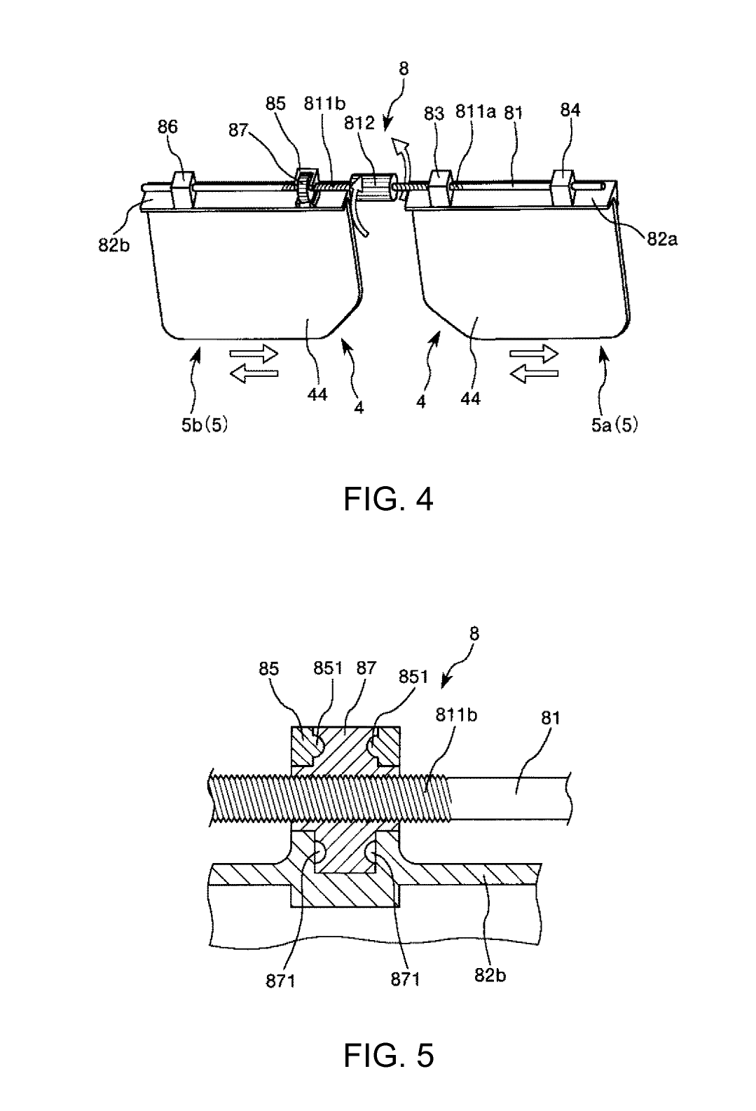

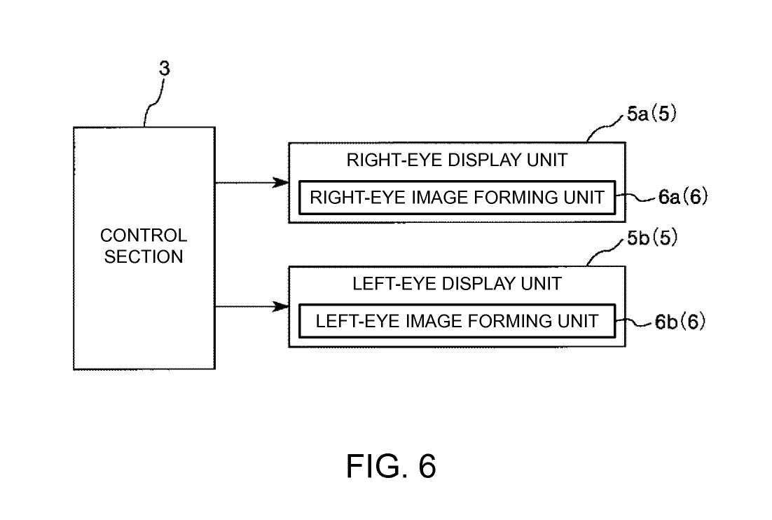

FIG. 1 is a perspective view showing a schematic configuration of an image display device (head mount display) according to a first embodiment of the invention. FIG. 2 is a perspective view showing a schematic configuration of a principal part of the image display device shown in FIG. 1. FIG. 3 is a perspective view showing a schematic configuration of the vicinity of a right-eye image forming unit of the image display device shown in FIG. 1. FIG. 4 is a perspective view showing a schematic configuration of the vicinity of an interpupillary adjustment mechanism of the image display device shown in FIG. 1. FIG. 5 is a cross-sectional view showing a schematic configuration of the vicinity of a screw coupling section (a roller) of the image display device shown in FIG. 1. FIG. 6 is a block diagram of the image display device shown in FIG. 1.

As shown in FIG. 1, the image display device 1 according to the present embodiment is a head mount display (a head-mounted image display device) having an exterior appearance like a pair of spectacles, and is used while being mounted on the head of the observer, and allows the observer to visually recognize an image as a virtual image in a state of overlapping the external image.

As shown in FIGS. 1 through 6, the image display device 1 is provided with a frame 2, a right-eye display unit 5a and a left-eye display unit 5b supported by the frame 2, a control section 3, and an interpupillary adjustment mechanism 8 for adjusting the distance between the right-eye display unit 5a and the left-eye display unit 5b. The right-eye display unit 5a and the left-eye display unit 5b are each provided with an image forming section 4 having a reflecting section 44. It should be noted that a right-eye image forming unit 6a is formed of constituents of the image forming section 4 of the right-eye display unit 5a except the reflecting section 44. The right-eye image forming section 6a is a unit for generating image light for forming a virtual image to be displayed on the right eye. Similarly, a left-eye image forming unit 6b is formed of constituents of the image forming section 4 of the left-eye display unit 5b except the reflecting section 44. The left-eye image forming section 6b is a unit for generating image light for forming a virtual image to be displayed on the left eye.

It should be noted that in the present embodiment, the descriptions of “right-eye display unit 5a” and “left-eye display unit 5b” are used in the case of distinguishing between the right-eye display unit 5a and the left-eye display unit 5b, and the description of “display unit 5” is used in the case of not distinguishing therebetween. Similarly, in the present embodiment, the descriptions of “right-eye image forming unit 6a” and “left-eye image forming unit 6b” are used in the case of distinguishing between the right-eye image forming unit 6a and the left-eye image forming unit 6b, and the description of “image forming unit 6” is used in the case of not distinguishing therebetween.

Further, since the right-eye display unit 5a and the left-eye display unit 5b are identical to each other, one of the right-eye display unit 5a and the left-eye display unit 5b will be explained in the present embodiment.

In such an image display device 1, the virtual image for the right eye and the virtual image for the left eye, which can visually be recognized by the observer, are formed using the right-eye display unit 5a and the left-eye display unit 5b, respectively. It should be noted that the formation of the virtual image to the eye on the right side described above and the formation of the virtual image to the eye on the left side can simultaneously be performed, or it is also possible to perform only either one thereof.

Hereinafter, each of the constituents of the image display device 1 will sequentially be explained in detail.

### Frame

As shown in FIGS. 1 and 2, the frame 2 has a shape like a glassframe, and has a function of movably supporting the right-eye display unit 5a and the left-eye display unit 5b.

Further, as shown in FIG. 1, the frame 2 movably supports the right-eye display unit 5a and the left-eye display unit 5b, and has a front section 22 for supporting a nose pad section 21, a pair of temple sections 23 connected to the front section 22 and respectively abutting on the ears of the observer, and end cover sections 24 each of which is an end portion of the temple section 23 on the opposite side to the front section 22.

The nose pad section 21 abuts on the nose of the observer in use to support the image display device 1 with respect to the head of the observer. The front section 22 includes a rim section 25 and a bridge section 26.

Further, the frame 2 has a lid 27 in the front section 22. It should be noted that FIG. 2 shows the state in which the lid 27 is removed.

It should be noted that the shape of the frame 2 is not limited to those shown in the drawings as long as the frame 2 can be mounted to the head of the observer.

### Interpupillary Adjustment Mechanism

As shown in FIGS. 1, 2, and 4, the interpupillary adjustment mechanism 8 is provided with a lead screw 81 provided with a first male screw section 811a provided with a screw thread (a male screw) as a right-hand screw and a second male screw section 811b provided with a screw thread (a male screw) as a left-hand screw, a left-eye support section 82b for supporting the left-eye display unit 5b, and a right-eye support section 82a for supporting the right-eye display unit 5a. It should be noted that it is arranged that the left-eye display unit 5b moves in an axial direction (a longitudinal direction) of the lead screw 81 together with the left-eye support section 82b, and the right-eye display unit 5a moves in the axial direction of the lead screw 81 together with the right-eye support section 82a.

In the central portion of the lead screw 81, there is disposed an operation section 812 having a cylindrical shape. It should be noted that it is indisputable that the shape of the operation section 812 is not limited to the cylindrical shape.

Further, the right-eye support section 82a is provided with a support section 83 having a female screw to be screwed with the first male screw section 811a of the lead screw 81 provided to the inner peripheral surface, and a support section 84 for rotatably supporting the lead screw 81.

Further, the left-eye support section 82b is provided with a roller (a screw coupling section) 87 having a female screw to be screwed with the second male screw section 811b of the lead screw 81 provided to the inner peripheral surface, and a support section 86 for rotatably supporting the lead screw 81. Further, the left-eye support section 82b is provided with a support section 85 for rotatably supporting the roller 87 and the lead screw 81.

Further, a pair of projections (projection sections, rotation restriction sections) 851 having pressure contact with the roller 87 are disposed on the inner surface of the support section 85 so as to be opposed to each other. Further, a pair of side surfaces of the roller 87 are provided with a pair of grooves (recessed sections) 871, to which the pair of projections 851 are inserted, and which are formed along the rotational direction of the roller 87. Each of the grooves 871 has a ring-like shape viewed from the axial direction of the lead screw 81. By the projections 851 being inserted in the respective grooves 871, the rotation of the roller 87 is restricted by the frictional force acting between the grooves 871 and the projections 851 when rotating the lead screw 81, and thus, when the lead screw 81 rotates, the left-eye support section 82b is displaced. Further, the frictional force described above is set to a level at which the roller 87 can be rotated when trying to rotate the roller. In other words, the projections 851 do not restrict the rotation of the roller 87 when trying to rotate the roller 87.

It should be noted that the lead screw 81, the support section 83, the support section 85, and the roller 87 constitute a first adjustment mechanism capable of simultaneously adjusting the position of the left-eye display unit 5b and the position of the right-eye display unit 5a. Further, the lead screw 81, the support section 85, and the roller 87 constitute a second adjustment mechanism capable of independently adjusting only the position of the left-eye display unit 5b (only either one of the position of the left-eye display unit 5b and the position of the right-eye display unit 5a).

### Image Forming Section (Display Unit)

The image forming section 4 has a function of forming a virtual image as an image which can visually be recognized by the observer. Specifically, the image forming section 4 forms the virtual image based on a video signal (an image signal).

Although the attachment position of the image forming unit 6 corresponding to the constituents of the image forming section 4 except the reflecting section 44 is not particularly limited, the image forming unit 6 is attached to the reflecting section 44 with the attachment section 28 in the present embodiment as shown in FIG. 3. Thus, the image forming unit 6 is displaced together with the reflecting section 44, the positional relationship between the reflecting section 44 and the image forming unit 6 can always be kept constant. Thus, it is possible to prevent the incident angle of the light signal (light) emitted from the image forming unit 6 to the reflecting section 44 from changing when moving the reflecting section 44, and thus, an appropriate image can easily and surely be formed.

The image forming unit 6 is not particularly limited as long as the image forming unit 6 is provided with an optical section for forming the virtual image, and a scanning device and a non-scanning device, for example, can be cited as the image forming unit 6.

As the non-scanning device, there can be cited a projection type display device such as a projector using a liquid crystal or the like.

Further, as the scanning device, there can be cited, for example, a device having an light scanning section such as a light scanner for performing a scan with the light signal (light), and a generation section for generating the light signal with which the scan is performed by the light scanning section.

The reflecting section 44 is irradiated with such an optical signal emitted from the image forming unit 6.

The reflecting section 44 is disposed so as to be located in front of the eye of the observer when used. The reflecting section 44 has a function of reflecting the light signal, which has been emitted from the image forming section 4, toward the eye of the observer.

In the present embodiment, the reflecting section is a half mirror, and also has a function (a light transmissive property with respect to the visible light) of transmitting the external light. Specifically, the reflecting section 44 has a function of reflecting the light from the image forming section 4 and at the same time transmitting the external light proceeding from the outside of the reflecting section 44 toward the eye of the observer when used. Thus, it is possible for the observer to visually recognize the virtual image (the image) formed by the signal light beam while visually recognizing an external image. In other words, a see-through head mount display can be realized.

Although not shown, the reflecting section 44 has, for example, a transparent substrate (light transmitting section) for transmitting the external light, and a diffraction grating supported by the transparent substrate and for reflecting the signal light. Thus, it is possible to provide a variety of optical characteristics to the diffraction grating to thereby reduce the number of components of the optical system, or to thereby enhance the design flexibility. For example, by using a hologram element as the diffraction grating, it is possible to control the emission direction of the signal light reflected by the reflecting section 44. Further, by providing the diffraction grating with a lens effect, it is also possible to adjust the imaging state of the signal light reflected by the reflecting section 44.

It should be noted that the reflecting section 44 is not limited to the configuration described above, but can also be a device obtained by, for example, forming a semi-transmissive reflecting film formed of a metal thin film, a dielectric multilayer film, or the like on a transparent substrate.

In the present embodiment, the reflecting section 44 has a curved shape. It should be noted that the shape of the reflecting section 44 is determined in accordance with the arrangement of the image forming unit 6 and the characteristics of the reflecting section 44, and is not limited to the shape shown in the drawings.

### Control Section

The control section 3 has a function of, for example, controlling an operation of each section such as the image forming unit 6, namely the operation of the whole of the image display device 1.

Although the attachment position of the control section 3 is not particularly limited, the control section 3 is incorporated in the frame 2 in the present embodiment.

As the control section 3, there can be used, for example, a microcomputer or a CPU.

Then, the interpupillary adjustment of the image display device 1 will be explained based on FIG. 4.

In performing the interpupillary adjustment, the observer wears the image display device 1, and firstly, rotationally operates the operation section 812. Thus, the lead screw 81 rotates, and the left-eye support section 82b and the right-eye support section 82a are displaced in respective directions opposite to each other. On this occasion, the position of the reflecting section 44 of the right-eye display unit 5a is adjusted.

Further, at this stage, the position of the reflecting section 44 of the left-eye display unit 5b is coarsely adjusted. Thus, the interpupillary adjustment can promptly be performed compared to the case in which the interpupillary adjustment mechanism is formed of an adjustment mechanism capable of independently adjust only the position of the left-eye display unit and an adjustment mechanism capable of independently adjust only the position of the right-eye display unit.

Then, the observer rotates the roller 87. Thus, only the left-eye support section 82b is displaced. On this occasion, the position of the reflecting section 44 of the left-eye display unit 5b is adjusted. In such a manner as described hereinabove, the interpupillary adjustment is complete.

In such a manner as described above, the interpupillary adjustment can appropriately be performed for every observer, and it is possible to form the virtual image at the correct position for each of the right and left eyes.

According to such an image display device as explained hereinabove, the interpupillary adjustment can appropriately be performed for every observer, and it is possible to form the virtual image at the correct position for each of the right and left eyes.

Further, the interpupillary adjustment can promptly be achieved compared to the case in which the interpupillary adjustment mechanism is formed of the adjustment mechanism capable of independently adjust only the position of the left-eye display unit and the adjustment mechanism capable of independently adjust only the position of the right-eye display unit.

### Second Embodiment

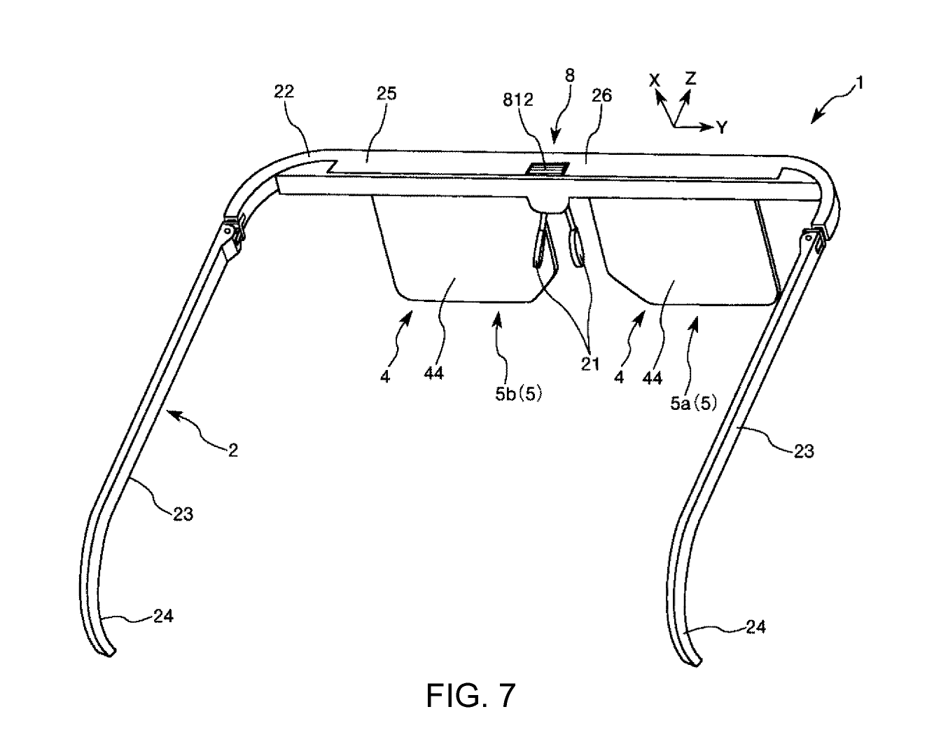

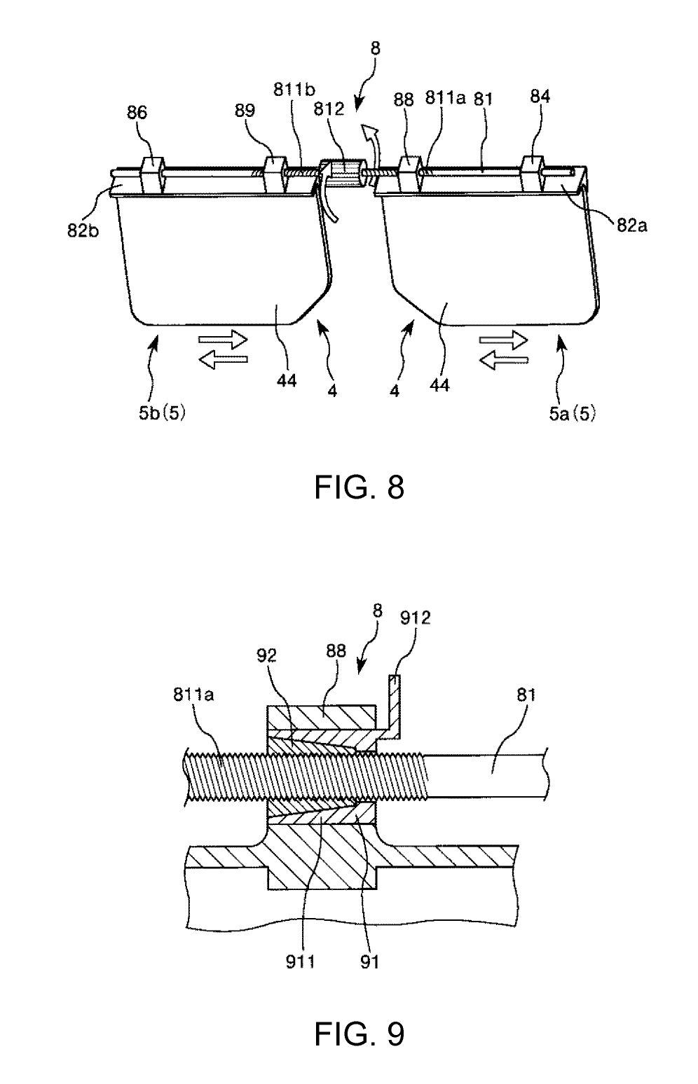

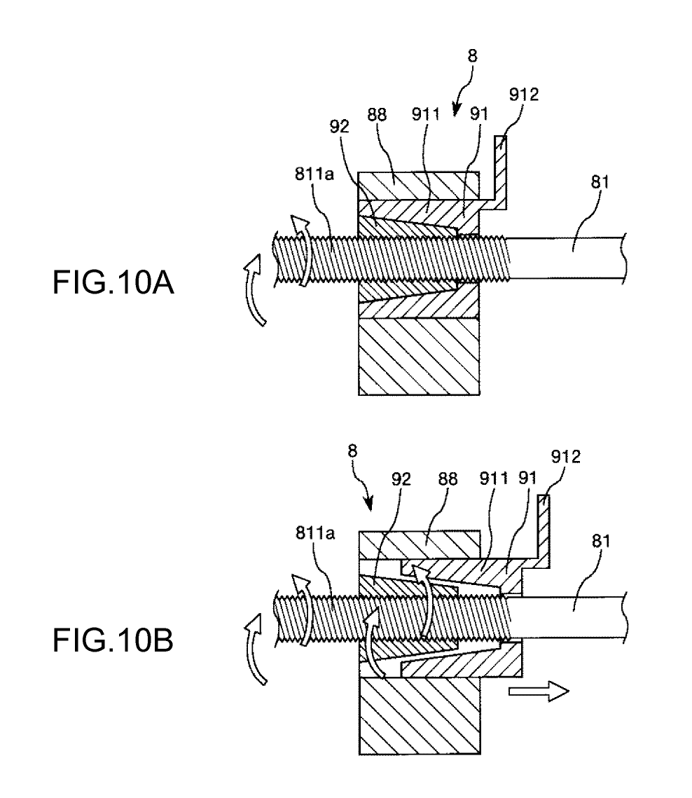

FIG. 7 is a perspective view showing a schematic configuration of an image display device (head mount display) according to a second embodiment of the invention. FIG. 8 is a perspective view showing a schematic configuration of the vicinity of an interpupillary adjustment mechanism of the image display device shown in FIG. 7. FIG. 9 is a cross-sectional view showing a schematic configuration of the vicinity of a clutch mechanism of the image display device shown in FIG. 7. FIGS. 10A and 10B are cross-sectional views respectively showing a rotation-restricted state and a rotation-allowed state of the image display device shown in FIG. 7.

Hereinafter, the second embodiment will be described focused mainly on the differences from the embodiment described above, and the explanation of substantially the same matters will be omitted.

The image display device according to the second embodiment is substantially the same as the device according to the first embodiment described above except the point that the interpupillary adjustment mechanism is different.

As shown in FIGS. 7 through 9, in the interpupillary adjustment mechanism 8 of the image display device 1 according to the present embodiment, the right-eye support section 82a is provided with a nut (a screw coupling section) 92 having a female screw to be screwed with the first male screw section 811a of the lead screw 81 provided to the inner peripheral surface, and a support section 84 for rotatably supporting the lead screw 81.

Further, a support section 88 and a clutch 91 supported by the support section 88 so as to be able to be displaced in the axial direction of the lead screw 81 are further provided to the right-eye support section 82a so as to be disposed at the position of the nut 92.

The clutch 91 has a cylindrical section (a main body section) 911 having a cylindrical shape, and an operation section 912 which can be gripped by the observer. Further, the clutch 91 is arranged to be displaced in the axial direction to thereby switch between a rotation-restricted state in which the relative rotation between the nut 92 and the right-eye support section 82a is restricted and a released state (a rotation-allowed state in which the relative rotation is allowed) in which the restriction of the relative rotation between the nut 92 and the right-eye support section 82a is released. The clutch 91 is arranged so that the cylindrical section 911 is fitted into the space between the outer peripheral surface of the nut 92 and the support section 88 of the right-eye support section 82a in the rotation-restricted state, and the fit with the space is released in the rotation-allowed state.

Further, the outer peripheral surface of the nut 92 is tilted with respect to the axial direction of the lead screw 81, and the inner peripheral surface of the cylindrical section 911 is tilted in the same direction as that of the outer peripheral surface of the nut 92 with respect to the axial direction of the lead screw 81. Thus, it is possible to easily and surely switch between the rotation-restricted state and the rotation-allowed state, and thus, it is possible to surely take the rotation-restricted state and the rotation-allowed state.

Further, the left-eye support section 82b is provided with a support section 89 having a female screw to be screwed with the second male screw section 811b of the lead screw 81 provided to the inner peripheral surface, and a support section 86 for rotatably supporting the lead screw 81.

It should be noted that the lead screw 81, the support section 88, the support section 89, the clutch 91, and the nut constitute the first adjustment mechanism capable of simultaneously adjusting the position of the left-eye display unit 5b and the position of the right-eye display unit 5a. Further, the lead screw 81, the support section 89, the clutch 91, and the nut 92 constitute the second adjustment mechanism capable of independently adjusting only the position of the left-eye display unit 5b (only either one of the position of the left-eye display unit 5b and the position of the right-eye display unit 5a).

Then, the interpupillary adjustment of the image display device 1 will be explained based on FIGS. 10A and 10B.

In performing the interpupillary adjustment, the observer wears the image display device 1, and, as shown in FIG. 10A, firstly grips the operation section 912, and displaces the clutch 91 leftward in the drawing to fit the cylindrical section 911 of the clutch 91 into the space between the outer peripheral surface of the nut 92 and the support section 88 to set the rotation-restricted state. Then, the observer rotationally operates the operation section 812. Thus, the lead screw 81 rotates, and the left-eye support section 82b and the right-eye support section 82a are displaced in respective directions opposite to each other. On this occasion, the position of the reflecting section 44 of the right-eye display unit 5a is adjusted.

Further, at this stage, the position of the reflecting section 44 of the left-eye display unit 5b is coarsely adjusted. Thus, the interpupillary adjustment can promptly be performed compared to the case in which the interpupillary adjustment mechanism is formed of an adjustment mechanism capable of independently adjust only the position of the left-eye display unit and an adjustment mechanism capable of independently adjust only the position of the right-eye display unit.

Then, as shown in FIG. 10B, the observer grips the operation section 912, and displaces the clutch 91 rightward in the drawing to release the fit to set the rotation-allowable state, and then rotationally operates the operation section 812. Thus, only the left-eye support section 82b is displaced. On this occasion, the position of the reflecting section 44 of the left-eye display unit 5b is adjusted.

In such a manner as described above, the interpupillary adjustment can appropriately be performed for every observer, and it is possible to form the virtual image at the correct position for each of the right and left eyes.

According also to such a second embodiment as described above, substantially the same advantages as in the first embodiment can be obtained.

Although the image display device according to the invention is explained hereinabove based on the illustrated embodiments, the invention is not limited to these embodiments. For example, in the image display device according to the invention, the configuration of each section can be replaced with an arbitrary configuration having substantially the same function, and further, it is also possible to add other arbitrary constituents.

Further, the invention can be the combination of any two or more configurations (features) of the embodiments described above.

Further, although in the above description of the embodiments described, the case of applying the invention to the spectacle shaped head mount type image display device is explained as an example, the invention is not limited to this example providing the virtual image is formed as an image visually recognized by the observer, but can also be applied to, for example, a helmet-type or headset-type head mount type display, and an image display device having a configuration of being supported by the body of the observer such as the neck or the shoulder.

Further, although in the embodiments described above, the case in which the whole of the image display device is mounted on the head of the observer is explained as an example, it is also possible for the image display device to be provided with a part, which is mounted on the head of the observer, and a part, which is carried or mounted on a part of the observer other than the head.

Further, although in the embodiments described above, the case in which the second adjustment mechanism is configured so as to be able to independently adjust only the position of the left-eye display unit is explained as an example, in the invention, it is also possible for the second adjustment mechanism to be configured so as to be able to independently adjust only the position of the right-eye display unit.

The entire disclosure of Japanese Patent Application No. 2014-135915, filed Jul. 1, 2014 is expressly incorporated by reference herein.

What is claimed is:

1. An image display device used while mounted on a head of an observer comprising:
a left-eye display unit having an optical section adapted to form a virtual image for a left eye of the observer;
a right-eye display unit having an optical section adapted to form a virtual image for a right eye of the observer; and
an interpupillary adjustment mechanism adapted to adjust a distance between the left-eye display unit and the right-eye display unit,
wherein the interpupillary adjustment mechanism includes
a first adjustment mechanism capable of simultaneously adjusting a position of the left-eye display unit and a position of the right-eye display unit, and
a second adjustment mechanism capable of independently adjusting only either one of the position of the left-eye display unit and the position of the right-eye display unit.

2. The image display device according to claim 1, wherein
the interpupillary adjustment mechanism includes
a lead screw provided with a first male screw section provided with a screw thread formed in a first screw direction, and a second male screw section provided with a screw thread formed in a second screw direction different from the first screw direction,
a left-eye support section adapted to support the left-eye display unit, and
a right-eye support section adapted to support the right-eye display unit,
either one of the left-eye support section and the right-eye support section is provided with a female screw to be screwed with the first male screw, and
the other of the left-eye support section and the right-eye support section is provided with a screw coupling section, which has an inner peripheral surface provided with a female screw to be screwed with the second male screw, and is rotatable with respect to the other of the left-eye support section and the right-eye support section.

3. The image display device according to claim 2, further comprising:
a rotation restriction section adapted to restrict a rotation of the screw coupling section when rotating the lead screw, and not to restrict a rotation of the screw coupling section when rotating the screw coupling section.

4. The image display device according to claim 3, wherein
the rotation restriction section has a projection section provided to the other of the left-eye support section and the right-eye support section, and having pressure contact with the screw coupling section.

5. The image display device according to claim 4, wherein
the screw coupling section has a recessed section to which the projection section is inserted.

6. The image display device according to claim 2, further comprising:
a clutch adapted to switch between a rotation-restricted state in which a relative rotation between the screw coupling section and the other of the left-eye support section and the right-eye support section is restricted, and a rotation-allowed state in which the relative rotation between the screw coupling section and the other of the left-eye support section and the right-eye support section is allowed.

7. The image display device according to claim 6, wherein
the clutch is fitted into a space formed between an outer peripheral surface of the screw coupling section and the other of the left-eye support section and the right-eye support section in the rotation-restricted state, and
the fit of the clutch into the space is released in the rotation-allowed state.

8. The image display device according to claim 7, wherein
the outer peripheral surface of the screw coupling section is tilted with respect to an axial direction of the lead screw.

9. The image display device according to claim 8, wherein
the clutch has a cylindrical section having a cylindrical shape, and
an inner peripheral surface of the cylindrical section is tilted with respect to the axial direction of the lead screw.
